(19) United States
(12) Patent Application Publication
(10) Pub. No.: US 2016/0217481 A1
(43) Pub. Date: Jul. 28, 2016

(54) COMMUNICATION SYSTEM AND SERVER FOR CONDUCTING USER EXPERIENCE STUDY

(71) Applicant: Jacqueline Stetson PASTORE, Miami, FL (US)

(72) Inventor: Jacqueline Stetson PASTORE, Miami, FL (US)

(21) Appl. No.: 15/007,828

(22) Filed: Jan. 27, 2016

Related U.S. Application Data
(60) Provisional application No. 62/108,322, filed on Jan. 27, 2015.

(51) Int. Cl. G06Q 30/02

(52) U.S. Cl. CPC G06Q 30/0203

(57) ABSTRACT

A communication system is for conducting a user experience study. The communication system may include a server, and communications devices respectively associated with participants for the user experience study. The server may be configured to generate a participant interface for conducting the user experience study with the participants via the communications devices, and generate user experience data from the user experience study and store the user experience data in the memory.

### RELATED APPLICATION

This application is based upon prior filed copending Application No. 62/108,322 filed Jan. 27, 2015, the entire subject matter of which is incorporated herein by reference in its entirety.

### TECHNICAL FIELD

The present disclosure relates to the field of communication systems, and, more particularly, to communication system for usability studies and related methods.

### SUMMARY

Generally speaking, a communication system is for conducting at least one user experience study. The communication system may include a server comprising a processor and memory associated therewith, and a plurality of communications devices respectively associated with a plurality of participants for the at least one user experience study, each communications device comprising a processor and memory associated therewith. The server may be configured to generate a participant interface for conducting the at least one user experience study with the plurality of participants via the plurality of communications devices, and generate user experience data from the at least one user experience study and store the user experience data in the memory.

The server may be configured to provide the at least one user experience study for download via the plurality of communications devices. Each communications device may comprise at least one input device and at least one sensor device, and the server may be configured to generate the user experience data by at least collecting data from the at least one input device and the at least one sensor device. The server may be configured to send at least one recruiting message to potential participants.

The server may be configured to store historical data regarding prior participants from at least one prior user experience study, and select the potential participants based upon the stored historical data. The server may be configured to provide a moderator interface for moderating the at least one user experience study. The moderator interface may comprise a pre-test questionnaire, at least one observer question, and a post-test interview.

The moderator interface may be configured to receive moderator data regarding the at least one user experience study. The server is configured to provide an observer interface. Each communications device may comprise at least one of a tablet computing device, a personal computing device, and a mobile cellular device, for example.

Another aspect is directed to a server in a communication system for conducting at least one user experience study, the communication system comprising a plurality of communications devices respectively associated with a plurality of participants for the at least one user experience study. The server may comprise a processor and memory associated therewith and configured to generate a participant interface for conducting the at least one user experience study with the plurality of participants via the plurality of communications devices, and generate user experience data from the at least one user experience study and store the user experience data in the memory.

Another aspect is directed to a method for operating a server in a communication system for conducting at least one user experience study, the communication system comprising a plurality of communications devices respectively associated with a plurality of participants for the at least one user experience study. The method may comprise operating a processor and memory associated therewith to generate a participant interface for conducting the at least one user experience study with the plurality of participants via the plurality of communications devices, and generate user experience data from the at least one user experience study and store the user experience data in the memory.

### BRIEF DESCRIPTION OF THE DRAWINGS

FIG. 1 is a schematic diagram of a communication system, according to the present disclosure.

FIGS. 2-8 are flowcharts illustrating operation of the communication system of FIG. 1.

FIG. 9 is an example home page for the interface of the communication system of FIG. 1.

FIGS. 10-28 are examples of varying parts of the interface of the communication system of FIG. 1.

### DETAILED DESCRIPTION

The disclosed embodiments relate to and provide for the creation, use, re-use and moderating of a user experience study such as e.g., a usability test, ethnographic research, stakeholder interviews, and user interviews. The disclosed embodiments allow user experience (“UX”) professionals (i.e., someone who is focused solely on the experience a user has with the product and company) to create, run and/or monitor e.g., user experience studies in a more effective and efficient manner. In one embodiment, a system and method can be implemented via a website operated by a server accessible over the Internet or other network by the UX professional, participant, observer and/or other user (hereinafter collectively referred to as the “user”). In another embodiment, a system and method can be implemented using an application that can be downloaded onto a mobile device (e.g., smartphone, tablet) and accessed by the user via the mobile device.

As will become apparent from the present disclosure, the needs and advantages of the embodiments disclosed herein include, but are not limited to: reducing repetitive tasks, streamlining data aggregation, automating charting, simplifying recruiting and scheduling, and data mining of participant data.

Users will be able to interface with the disclosed systems and method via any of the following devices using e.g., an Internet connection, mobile application, or API (as appropriate for the device): a personal computer (PC)/laptop computer, tablet, smartphone, web application, or a mobile application (e.g., operating on an Iphone, Android phone). The disclosed system and method can be accessed by e.g., a participant using social media such as e.g., Twitter, Facebook, and other social networks.

As noted above, users of the disclosed system and method will include UX professionals, participants and/or observers. Depending upon the type of user and activity/results the user desires, the disclosed system and method will provide at least the following functionality.

The disclosed system and method will implement a moderator guide function (also referred to herein or in the Drawings as a “Mod Guide”) that will allow a UX professional (the moderator) to create studies so that the UX professional can follow a moderator guide during a session and take notes during the session. The Mod Guide functionality will also allow a UX professional to follow a digital mod guide during a usability test so that the UX professional can have a template to follow during the testing. In addition, the Mod Guide functionality allows an observer to write notes to the moderator so that the observer has the moderator ask questions to the participant without the participant having knowledge of the observer and seeing what the observer is asking.

The disclosed system and method will implement a data entry function that will allow a UX professional and/or observer to take notes during a test so that the UX professional can have everything in digital form and by timestamp. From the observer's point of view, the entered data would be time-stamped quantifiable observable behavior from the observer and/or other observers. In one embodiment, the moderator can take photos, videos, audio recordings, and/or create drawings as part of a data collection function. The disclosed system and method will implement a charts function allowing a UX professional to view charts that quantify observable behavior so that the UX professional does not have to transcribe them; the charts will be created automatically. The charts can be e.g., counts of an event, time between events, trends, etc. The charts function allows the UX professional to view a chart that represents data collection from more than one user so that the UX professional can see what trends there are in the data.

In one embodiment, a recruiting function is provided to allow the UX professional to: (1) send out a screener questionnaire to many participants for them to fill out so the UX professional can recruit people for its usability test; (2) schedule participants for tests so the UX professional can keep all the participant data in one place and in one system; and (3) look through a database of participant information to find participants so the UX professional can refer to her own list of people to recruit from. The recruiting function will also provide a participant the ability to have an account on the disclosed platform that lists answers from many different recruiting screeners so that the participant can be available for as many tests as possible and earn rewards for answering screener surveys.

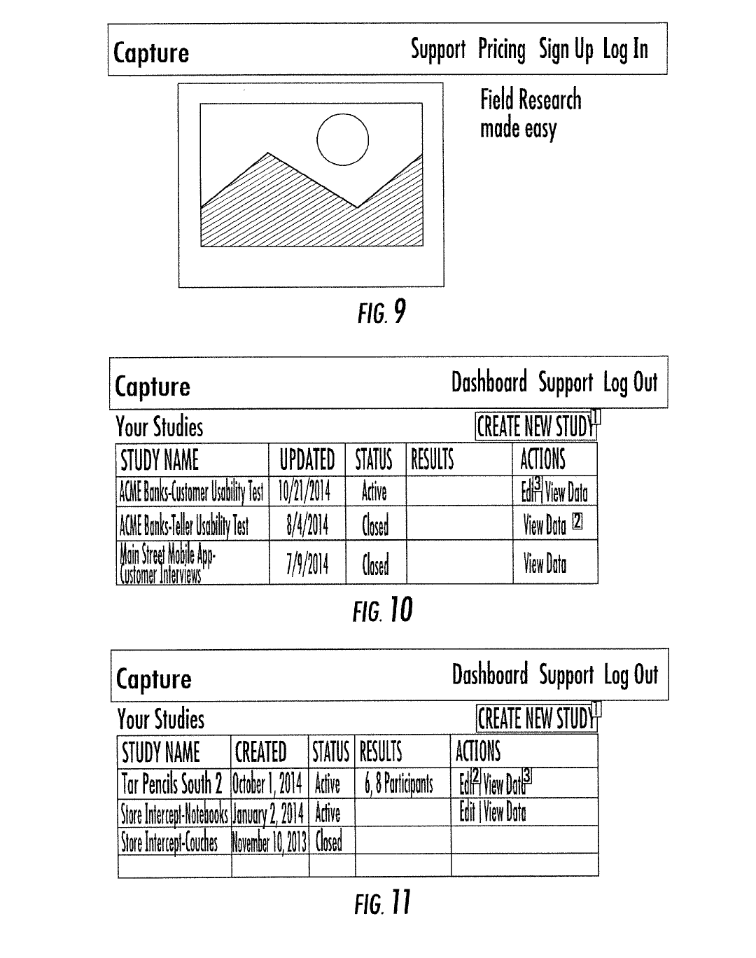

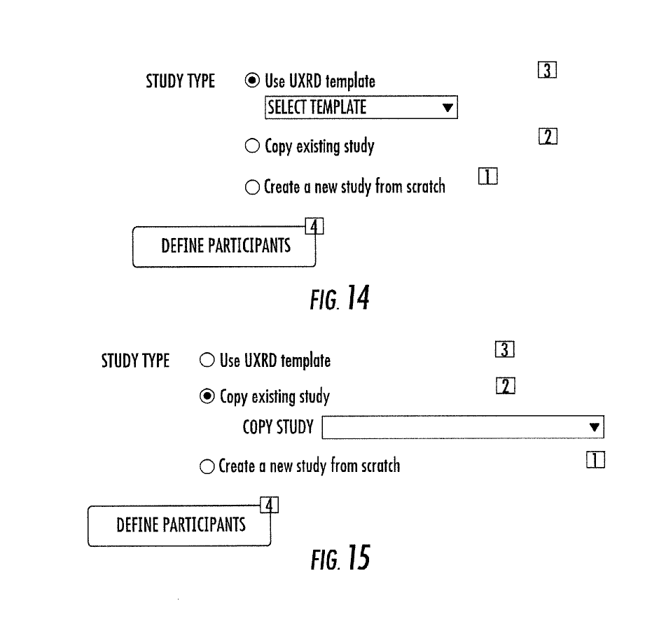

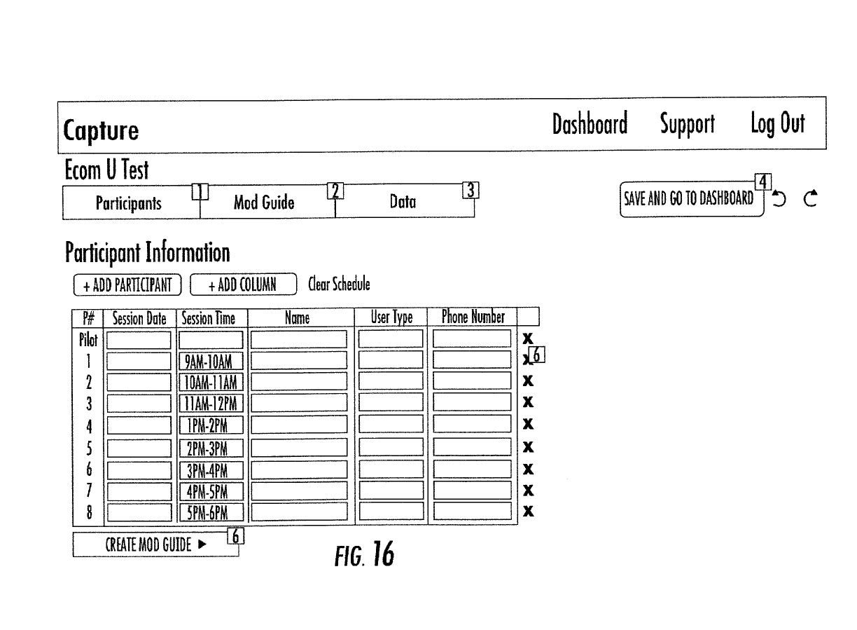

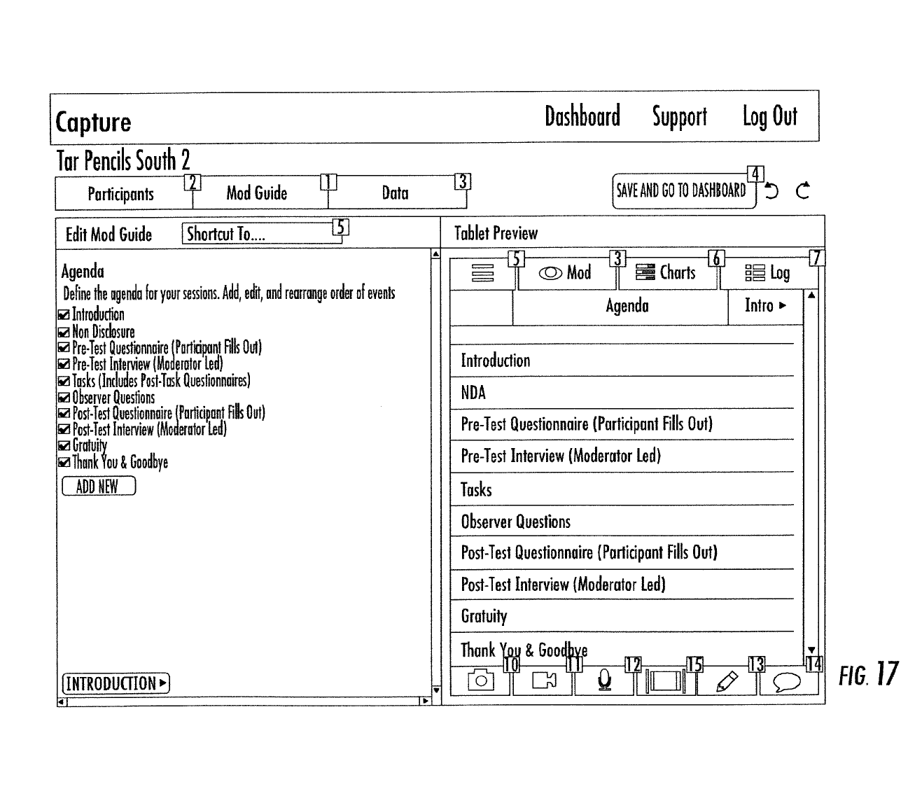

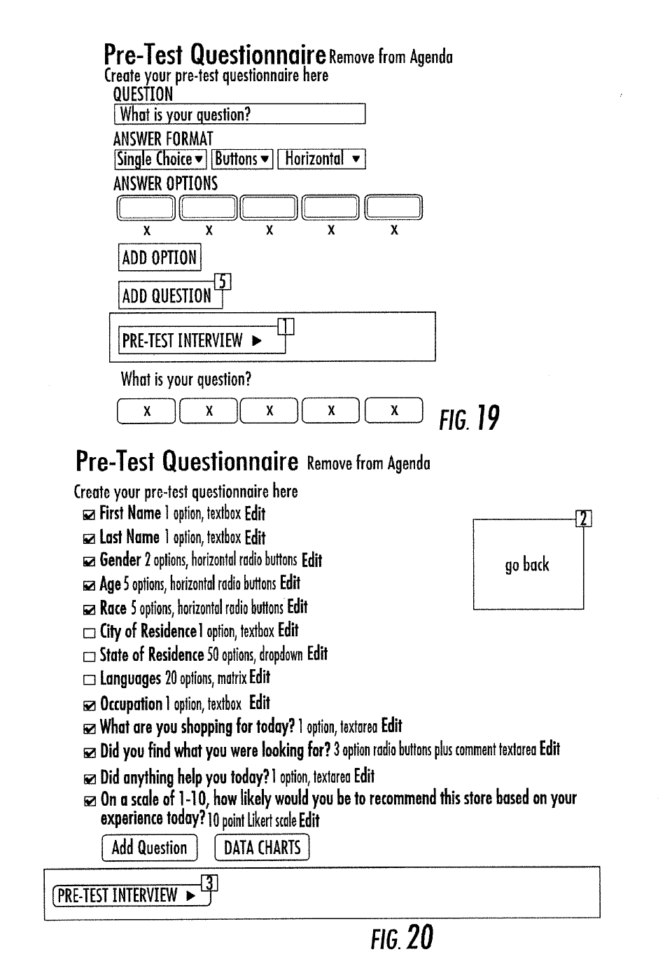

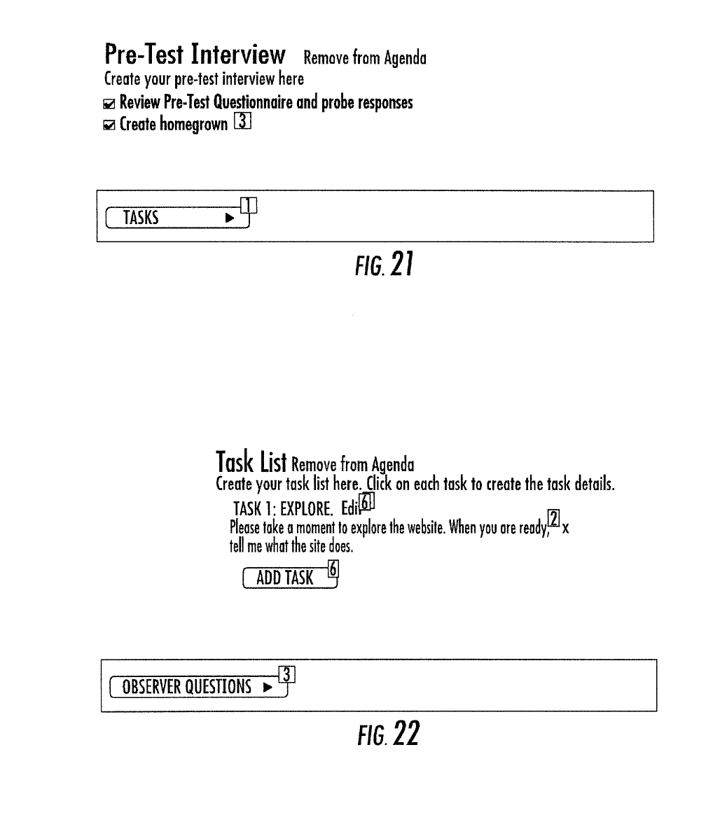

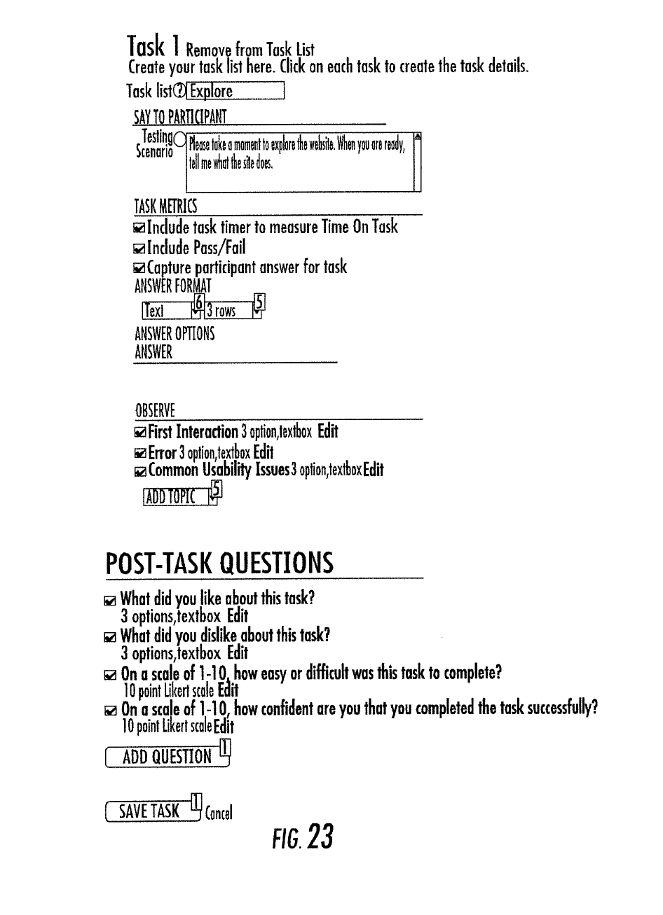

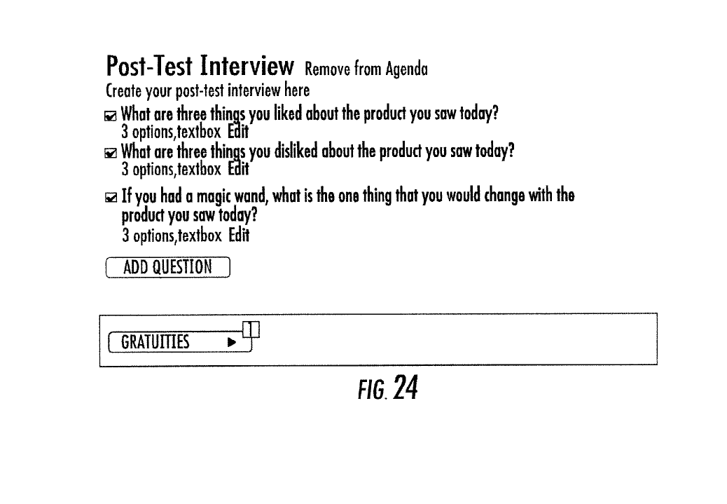

Tables 1 and 2 set at the end of this document and before the Drawings include example functionality provided by the disclosed embodiments. Table 1, for example, lists the functionality associated with creating a viability study and actions/observations of the moderator, participant and observer(s). Table 2 lists functionality and actions/observations of the moderator, participant and observer(s) provided by a tablet or web application implementing the processing disclosed herein. The tables also list “pages” that could be displayed during the operation of the disclosed embodiments. Some of those pages are illustrated in FIGS. 9-25.

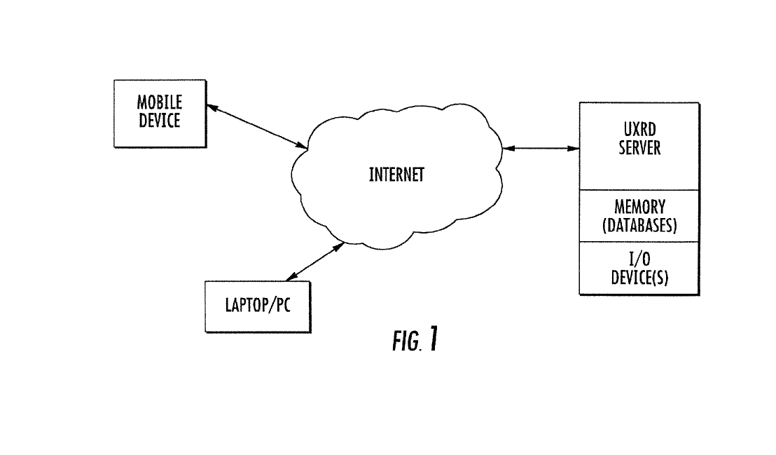

In one embodiment, the disclosed method is implemented in software (i.e., computer instructions) that are stored in a computer readable memory and executed by a processor. The disclosed method implements a tool, sometimes referred to herein or in the Drawings as the UX Gofer tool. FIG. 1 illustrates an example system comprising a user experience research and development (“UXRD”) server for operating an embodiment of the method disclosed herein. The server includes or is connected to a memory for storing computer instructions required to implement the method described herein and to store the various databases, user information, information for generating the various displays disclosed herein used during the above-described processes. The server can be accessed over a wired or wireless network (shown as the Internet in this example). User devices include a mobile device such as a smartphone or a tablet (i.e., iPad, Galaxy, Surface, etc.) and a laptop/PC that connect to the server via the network. The server can include input/output devices such as keyboards, displays, scanners, printers, etc.

According to an embodiment disclosed herein, a public website will be created and associated with the disclosed system and method. The web site allows a potential customer to learn about the disclosed UX Gofer tool and decide if he/she wants to use it. The website allows the potential customer to purchase the tool so the customer can use it. The web site allows the customer to read/search a customer support board, blog or FAQs page so that the customer can have its technical/operational problems/issues resolved. The web site can contain “how to” videos so that the customer can learn how to use the tool. The web site can allow customers to submit a help ticket to get help from someone associated with the workings of the tool. The web site allows the customer to create an account and log into the tool so that the customer can get access to its account information, active and completed studies, results, etc. The web site can also allow the customer to reset its password or have its current password resent to the customer. FIG. 9 illustrates an example home page for the tool.

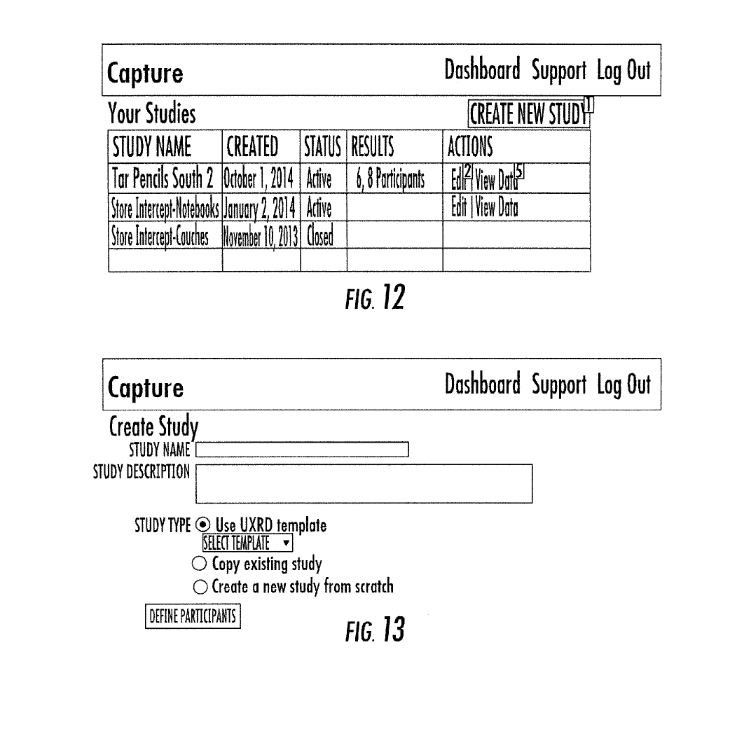

The embodiments disclosed herein will implement a “dashboard” providing e.g., a moderator with the ability to: (1) create a new study so that the moderator can create a test plan for the study; (2) view old study data allowing the moderator to export results and other test information; (3) edit a study to allow the moderator to finish setting up a study; and (4) sort table columns so that the moderator can organize studies by e.g., name, date, or status. FIG. 10 illustrates an example dashboard, FIG. 11 illustrates an example dashboard after creating a study, and FIG. 12 illustrates an example dashboard during a study.

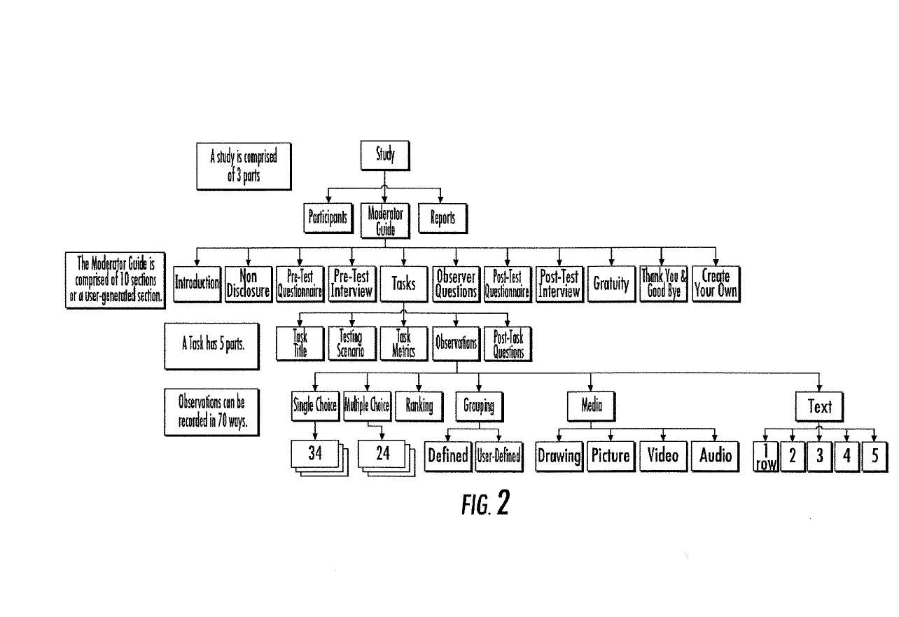

FIG. 2 illustrates the workflow for a user interface for implementing a method disclosed herein. The illustrated workflow is for creating a study, which as shown in the figure comprises three parts: the participant, the moderator guide and reports. Illustratively, the moderator guide includes ten tool-guided sections or one user customized section. The tool-guided sessions include: introduction, non disclosure, pre-test questionnaire, pre-test interview, tasks, observer questions, post-test questionnaire, post-test interview, gratuity, and thank you and goodbye sections. The user customized section is illustrated as “create your own” in the figure.

In the illustrated embodiment, tasks have five parts, which include: the task tile, testing scenario, task metrics, observations and post-task questions. As shown in FIG. 2, in the illustrated embodiment, observations can be recorded in 70 ways including 34 single choice options, 24 multiple choice options, rankings, groupings (defined by the method or the user), media (e.g., drawings, pictures, video and audio) and one or multiple rows of text.

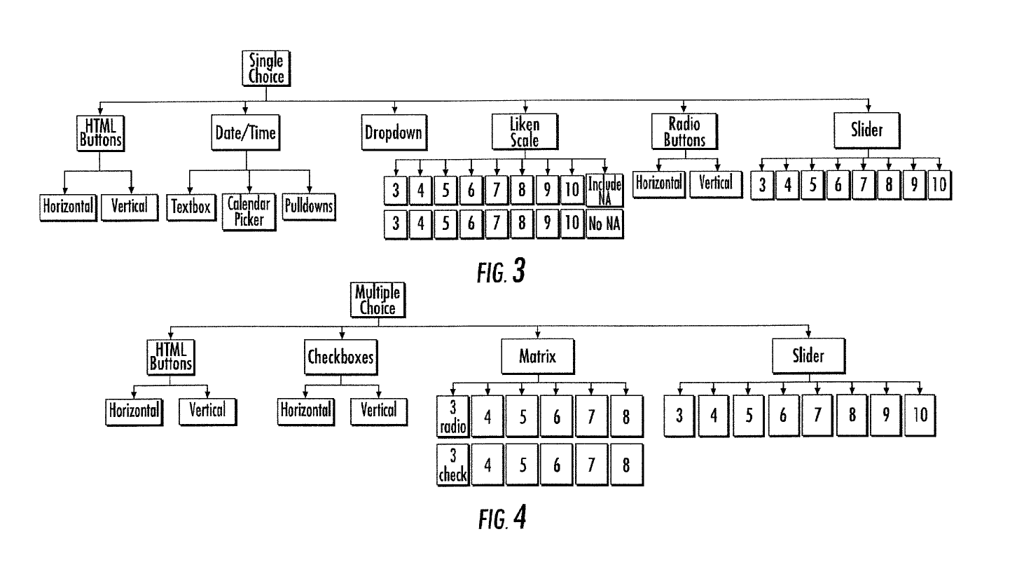

FIG. 3 illustrates the workflow for implementing single choice options (e.g., HTML buttons, date/time selections, dropdown menus, a Likert scale, radio buttons, and a slider). FIG. 4 illustrates the workflow for implementing multiple choice options (e.g., HTML buttons, checkboxes, a matrix, and a slider). One of ordinary skill in the art would understand how to implement these options for the disclosed system and method using the appropriate software language and tools. Moreover, one of ordinary skill in the art would understand how to implement the following functionality, including the displayed pages, using the appropriate software language and tools.

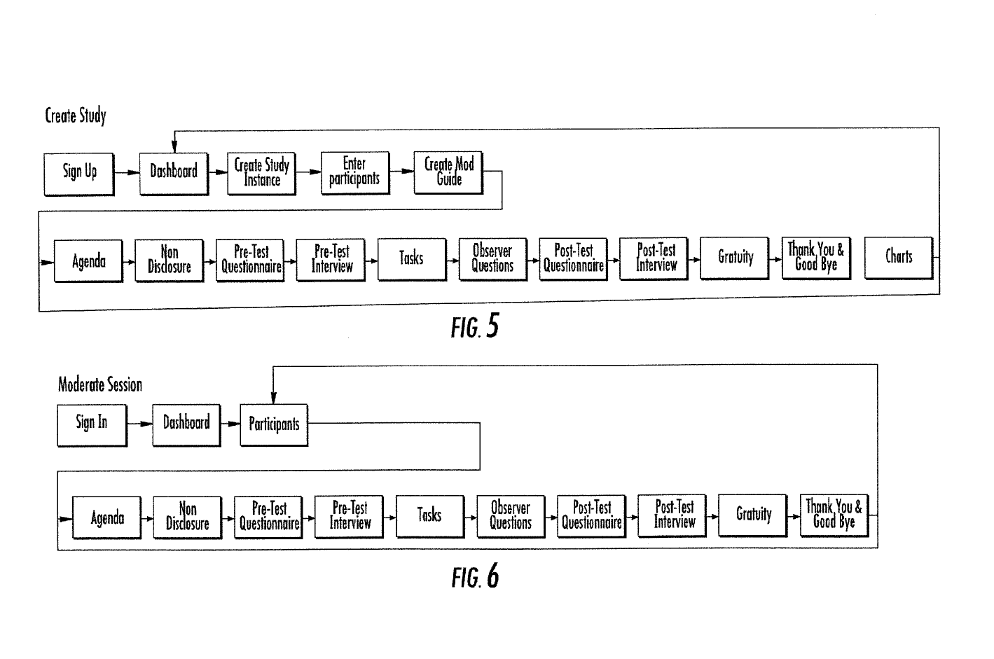

FIG. 5 illustrates an example workflow for creating a study in accordance with the disclosed principles. The creator of the study signs up to use the tool via the web or tablet application. If the creator already has an account, then the creator would log on using its username and password. The creator is presented with its current dashboard (see e.g., FIGS. 10-12) and selects create a study. Example pages that could be displayed to the creator are shown in FIGS. 13-15.

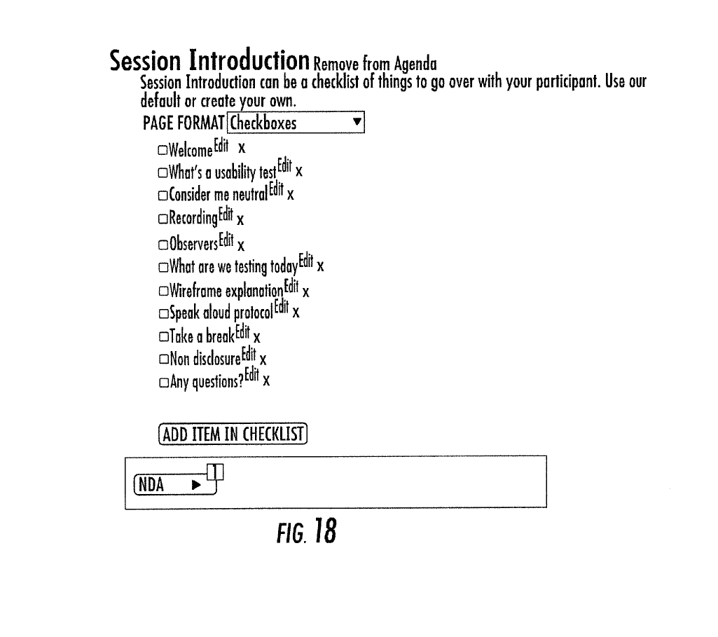

The creator can enter participant information and then elect to create the moderator guide. An example page that could be displayed to the creator is shown in FIG. 16. Creating the moderator guide includes setting the agenda for the study by selecting or unselecting choice boxes for the introduction, non-disclosure, pre-test questionnaire, pre-test interview, tasks, observer questions, post-test questionnaire, post-test interview, gratuity, and thank you and goodbye sections. An example page that could be displayed to the creator is shown in FIG. 17. In one embodiment, a default agenda is provided (e.g., all boxes are selected) allowing the creator of the study to use the default agenda or deselect options to create a customized one. An option to add a new feature to the agenda is also provided.

The creator is then presented pages to set up the options for the selected agenda items (i.e., introduction, non-disclosure, pre-test questionnaire, pre-test interview, tasks, observer questions, post-test questionnaire, post-test interview, gratuity, and thank you and goodbye sections). Example pages that could be displayed to the creator are shown in FIGS. 18 (introduction), 19 (pre-test questionnaire), 20 (pre-test questionnaire), 21 (pre-test interview), 22 (tasks), 23 (tasks), 24 (post-test interview) and 25 (gratuities). A charts option is also available as shown in FIG. 20. As can be seen, each page allows the creator to customize the information displayed during the study and the information collected during the study. Although not shown, the observer questions set-up page(s) provides the moderator with options for how observer questions are collected, displayed and responded to during an active study.

As can be seen in some of the Drawings, a page for the current agenda item can include a button to go to the next agenda item. For example, FIG. 18 illustrates an example page for the introduction agenda item, which has an “NDA” selection button so that the creator can be presented with the page for the non-disclosure section when the button is selected.

Once the study is created, it can be run and moderated by the moderator. An example workflow for allowing the moderator to moderate a study session is shown in FIG. 6. The moderator signs into the tool via the web or tablet application and then accesses its dashboard. If more than one study is in the dashboard, the moderator selects the study to activate or selects one that is already active. As shown in the illustrated example, the moderator can view the various portions of the agenda and/or the participants activity during the study. As set out in tables 1 and 2, the moderator can perform various functions including asking questions presented by an observer.

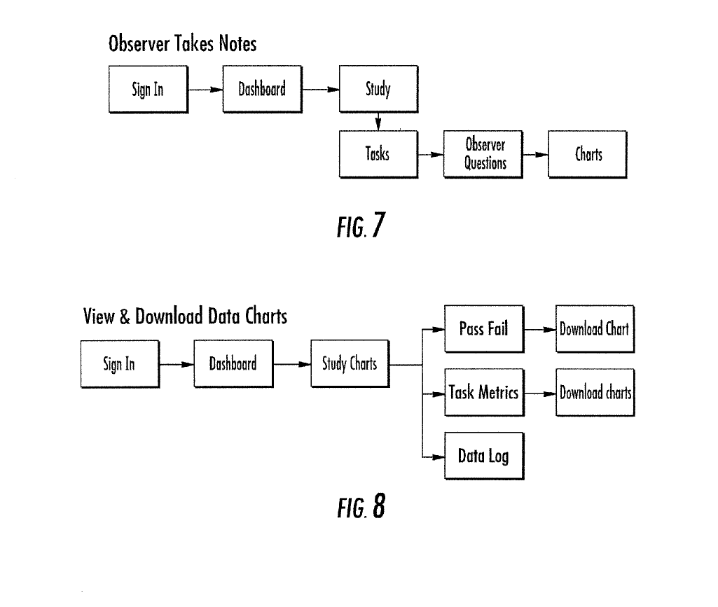

The disclosed system and method allow an observer to take notes during a study that are stored and associated with the study. An example workflow for this process is illustrated in FIG. 7. The observer signs into the tool via the web or tablet application and then accesses its dashboard. The observer selects the study to observe from the dashboard (there can be more than one study to observe). As shown in the illustrated example, the observer can view the tasks, send observer questions and enter/access data for the charts function discussed above.

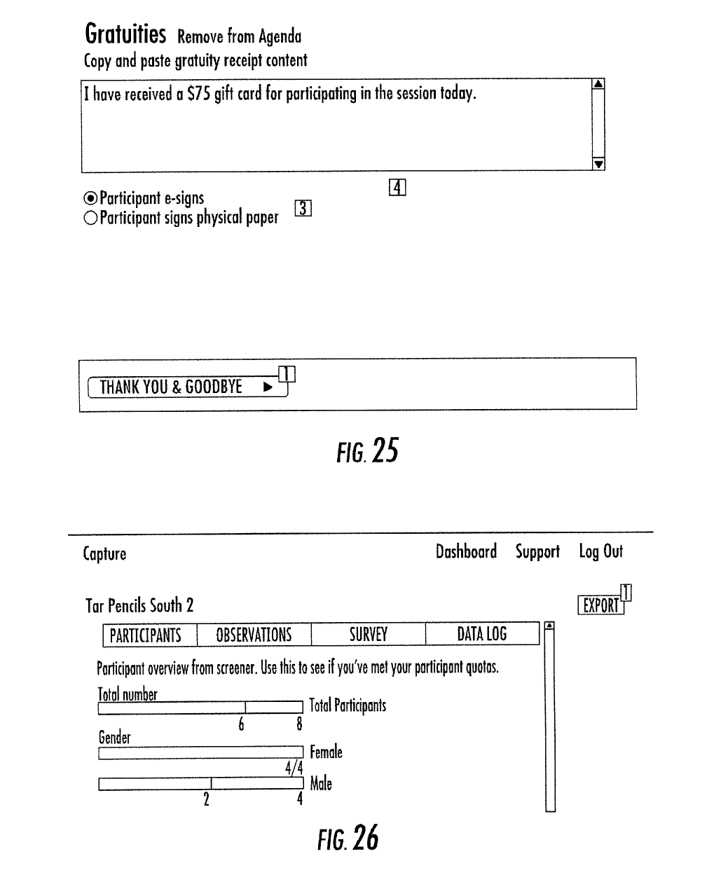

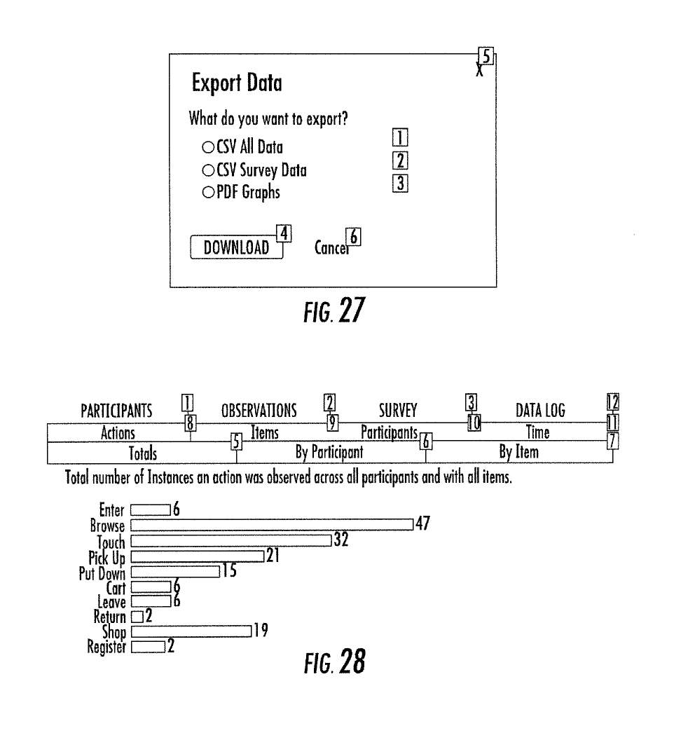

As shown in the example workflow illustrated in FIG. 8, charts can be viewed and/or downloaded by e.g., the moderator. Once the moderator logs into the system/method, she can access its dashboard and select to view or edit the data of a study. One preferred option is to study charts, which can include pass/fail and task metrics charts or a data log. The disclosed embodiments will also allow the moderator to download and/or print the charts. Although not shown in FIG. 8, the data log can also be downloaded or printed. Example pages that could be displayed to the moderator are shown in FIGS. 26-28. In another embodiment, the moderator may also be able to export all of the study information to a Word or PDF document referred to herein as a “Test Plan.” This function would allow the moderator to share study information with his/her client without the client having to log onto the site to see study data (participants, tasks, questionnaires, etc.).

Thus, the disclosed embodiments provide a simple interactive tool for creating, running, moderating and commenting on user experiences such as e.g., a research study. Test result data can be collected, quantified, sorted, charted, stored, downloaded, and exported for future use using the same tool used to create and run the study.

The various embodiments described above have been presented by way of example, and not limitation. It will be apparent to persons skilled in the art(s) that various changes in form and detail can be made therein without departing from the spirit and scope of the disclosure. In fact, after reading the above description, it will be apparent to one skilled in the relevant art(s) how to implement alternative embodiments. Thus, the disclosure should not be limited by any of the above-described exemplary embodiments.

TABLE 1
Create Viability Study

| As A | I Want To | So I Can | Page |
|---|---|---|---|
| Moderator | Create a new study from the | Have all the sections I need already | Create |
| | UXRD Usability Testing template | set up. | Study - |
| | | | Usability |
| | | | Test |
| Moderator | Create a new study from the | Have all the sections I need already | Create |
| | UXRD Ethnography template | set up. | Study - |
| | | | Usability |
| | | | Test |
| Moderator | Create a new study from the | Have all the sections I need already | Create |
| | UXRD Interview template | set up. | Study - |
| | | | Usability |
| | | | Test |
| Moderator | Create a new study from an old | Copy my own work and minimize | Create |
| | study | re-entry | Study - |
| | | | Usability |
| | | | Test |
| Moderator | Create a new study from scratch | Make the study exactly what I want | Create |
| | | | Study - |
| | | | Usability |
| | | | Test |
| Moderator | Define participants for my | Use that to take notes against. | Participants |
| | usability test (Add additional | | |
| | participants, delete participants, | | |
| | reorder participants, add additional | | |
| | columns, clear schedule, use | | |
| | default schedule.) | | |
| Moderator | Create my Mod Guide from the | Have all the sections I need already | Mod |
| | UXRD Template. Template | set up. | Guide - |
| | sections include intro, NDA, Pre- | | Agenda |
| | Test Questionnaire, Pre-Test | | |
| | Interview, Tasks, Observer | | |
| | Questions, Post-Test | | |
| | Questionnaire, Post-Test | | |
| | Interview, Gratuity, Thank You & | | |
| | Goodbye) | | |
| Moderator | Add additional sections to the mod | Have exactly what I need | Mod |
| | guide | | Guide - |
| | | | Agenda |
| Moderator | View a preview of the tablet view | Edit the mod guide appropriately so | All Study |
| | as I edit the Mod Guide | it makes sense for how it will appear | Pages |
| | | on the table. | |
| Moderator | Have the application save changes | Not have to remember to hit save | All Study |
| | as I make them | | Pages |
| Moderator | Have an undo and redo button | Fix mistakes easily | All Study |
| | | | Pages |
| Moderator | Save and exit study and go back to | Make triply sure that the study is | All Study |
| | dashboard | saved before I exit | Pages |
| Moderator | Have a shortcut to all mod guide | Quickly navigate between the pages | All Study |
| | sections | | Pages |
| Moderator | Have a ‘next’ type of button at the | Go through the site wizard-like. | All Mod |
| | bottom of the editable region that | | Guide |
| | takes me to the next section in the | | Pages |
| | agenda | | |
| Moderator | Have global navigation available | Go back to dashboard or get help if I | All |
| | to me from the edit study pages | need it. | Signed-In |
| | | | Pages |
| Moderator | Have study-level navigation on | Edit pages as I need to. | All Study |
| | page so I can go between | | Pages |
| | Participants, Mod Guide, and Data | | |
| | Charts | | |
| Moderator | Have the ability to remove a | Make the study exactly what I want | All Mod |
| | section from the agenda | | Guide |
| | | | Pages |
| Moderator | Be able to change the display | See what I need to do in the | Mod |
| | format of the session introduction | introduction exactly how I prefer. I | Guide - |
| | from checklists to paragraph text | can see just the checklist or I can | Session |
| | | read from a text script | Introduction |
| Moderator | Be able to edit items within a | Edit items within a checklist. | Mod |
| | checklist | | Guide - |
| | | | Session |
| | | | Introduction |
| Moderator | See changes in the Tablet Preview | Make sure it is displayed exactly | Mod |
| | as I make them in the edit view | how I want. | Guide - |
| | | | Session |
| | | | Introduction |
| Moderator | Be able to add items to a checklist | Have more items in a checklist | Mod |
| | | | Guide - |
| | | | Session |
| | | | Introduction |
| Moderator | Be able to delete items in a | Remove items in a checklist. | Mod |
| | checklist | | Guide - |
| | | | Session |
| | | | Introduction |
| Moderator | Be able to have a text editor if I | Make the text display exactly how I | Mod |
| | choose where I can write | want for when I run the sessions. | Guide - |
| | paragraphs, ordered and unordered | | Session |
| | lists, with basic text formatting | | Introduction |
| | (bold, italics, a few font options | | |
| | and sizes) | | |
| Moderator | Use the default NDA | Not have to find one of my own. | Mod |
| | | | Guide - |
| | | | NDA |
| Moderator | Be able to edit the NDA with my | Make my company's lawyers happy | Mod |
| | company's NDA | | Guide - |
| | | | NDA |
| Moderator | Be able to have the participant e- | Not have to worry about extra pieces | Mod |
| | sign the NDA during the session | of paper | Guide - |
| | by checking a box and using the | | NDA |
| | tablet for drawing their signature | | |
| Participant | Sign the NDA digitally using the | Not have to sign it on paper | Mod |
| | tablet app | | Guide - |
| | | | NDA |
| Moderator | Be able to add questions and | Collect data during sessions. These | All pages |
| | answer formats into the study. | must be web and mobile appropriate. | that have |
| | | | questions |
| Moderator | Single Choice - Buttons - | Enter options for the question. I can | All pages |
| | Horizontal | have as many or as few options as I | that have |
| | | need. I can remove options or | questions |
| | | reorder options. There should be a | |
| | | default number of 5 options when | |
| | | appropriate for user to fill out | |
| | | instead of having to add an object. | |
| | | See the answers horizontally on the | |
| | | screen when I am running the | |
| | | session. | |
| Moderator | Single Choice - Buttons - Vertical | See the answers ad vertical buttons | All pages |
| | | when I am running the sessions. | that have |
| | | | questions |
| Moderator | Single Choice - Date/Time - | See the date time as a text box when | All pages |
| | Textbox | I am running the sessions. | that have |
| | | | questions |
| Moderator | Single Choice - Date/Time - | See the date time as pull-downs | All pages |
| | Pulldowns | when I am running the sessions. | that have |
| | | | questions |
| Moderator | Single Choice - Date/Time - | See the date time as a calendar | All pages |
| | Calendar Picker | picker when I am running the | that have |
| | | sessions. | questions |
| Moderator | Single Choice - Dropdown | See the answers as pull-downs when | All pages |
| | | I am running the sessions. | that have |
| | | | questions |
| Moderator | Single Choice - Likert Scale - (3- | See the answers as a 3-10 point | All pages |
| | 10 options) | likert scale when I am running the | that have |
| | | sessions. | questions |
| Moderator | Single Choice - Likert Scale - | Have the ability to select N/A for a | All pages |
| | include a N/A option | question with a Likert Scale | that have |
| | | | questions |
| Moderator | Single Choice - Radio Buttons - | See the answers as vertical radio | All pages |
| | Vertical | buttons when I am running the | that have |
| | | sessions. | questions |
| Moderator | Single Choice - Radio Buttons - | See the answers as horizontal radio | All pages |
| | Horizontal | buttons when I am running the | that have |
| | | sessions. | questions |
| Moderator | Single Choice - Slider - (3-10 | See the answers as a slider with 3-10 | All pages |
| | options) | options when I am running the | that have |
| | | sessions. | questions |
| Moderator | Multiple Choice - Buttons - | See the answers as horizontal | All pages |
| | Horizontal | buttons when I am running the | that have |
| | | sessions and I can select more than | questions |
| | | one. | |
| Moderator | Multiple Choice - Buttons - | See the answers as vertical buttons | All pages |
| | Vertical | when I am running the sessions and I | that have |
| | | can select more than one. | questions |
| Moderator | Multiple Choice - Checkboxes - | See the answers as vertical | All pages |
| | Vertical | checkboxes when I am running the | that have |
| | | sessions and I can select more than | questions |
| | | one. | |
| Moderator | Multiple Choice - Checkboxes - | See the answers as horizontal | All pages |
| | Horizontal | checkboxes when I am running the | that have |
| | | sessions and I can select more than | questions |
| | | one. | |
| Moderator | Multiple Choice - Matrix - (1-8 | See the answers as matrix of choices | All pages |
| | columns) - radio buttons (single | that have 1-8 columns. Ability to | that have |
| | selection per row) | select one answer per row. | questions |
| Moderator | Multiple Choice - Matrix - (1-8 | See the answers as a matrix of | All pages |
| | columns) - checkmarks (multiple | choices that have 1-8 columns. | that have |
| | selections per row) | Ability to select multiple answers | questions |
| | | per row. | |
| Moderator | Ranking | Have the participant drag and drop | All pages |
| | | items into an order | that have |
| | | | questions |
| Moderator | Grouping - User-Defined Groups | Have the participant drag and drop | All pages |
| | | items into their own groups (card- | that have |
| | | sorting studies) | questions |
| Moderator | Grouping - Defined Groups | Have the participant drag items into | All pages |
| | | groups I define | that have |
| | | | questions |
| Moderator | Media - Picture | Take a picture as the answer to a | All pages |
| | | question. | that have |
| | | | questions |
| Moderator | Media - Video | Take a video as the answer to a | All pages |
| | | question. | that have |
| | | | questions |
| Moderator | Media - Voice Recording | Take a voice recording as the answer | All pages |
| | | to a question. | that have |
| | | | questions |
| Moderator | Media - Drawing | Allow user to draw on the ipad as | All pages |
| | | the answer to a question. | that have |
| | | | questions |
| Moderator | Text (1-5 rows) | Type in answers via an attached | All pages |
| | | keyboard or an on-screen touch | that have |
| | | keyboard | questions |
| Moderator | Ability to add questions to an | Ask multiple questions during a | All pages |
| | agenda section, having the first | session. | that have |
| | question populated by a Single | | questions |
| | Choice, Button, Horizontal, 5 | | |
| | options question | | |
| Moderator | Edit questions | Make sure the questions are asked | All pages |
| | | and displayed correctly. | that have |
| | | | questions |
| Moderator | Delete questions | Remove questions I don't want. | All pages |
| | | | that have |
| | | | questions |
| Moderator | Rearrange questions by drag and | Order questions in a way that makes | All pages |
| | drop | sense to me. | that have |
| | | | questions |
| Moderator | Use the pre-test questionnaire as | Review what the participant | Pre-Test |
| | the basis for my interview. In the | answered with them and take | Interview |
| | data entry side, I want a sticky note | additional notes. | |
| | text box where I can type | | |
| | additional notes | | |
| Moderator | Create a home-grown interview | Ask questions that I want during the | Pre-Test |
| | questionnaire where I create | interview. | Interview |
| | questions from scratch | | |
| Moderator | Add Tasks to the moderator guide. | Have the participant run through | Tasks |
| | The Task Template has 5 parts: | desired functionality | |
| | 1 - Task Title (Textbox) | | |
| | 2 - Say to Participant (Text Area) | | |
| | 3 - Task Metrics (Time on Task, | | |
| | Pass/Fail, Task Answer) | | |
| | 4 - Observe (Errors, Common | | |
| | Usability Issues) | | |
| | 5 - Post-Task Questions (Likes, | | |
| | Dislikes, Ease of use, confidence) | | |
| Moderator | Delete tasks | Remove unwanted tasks. | Tasks |
| Moderator | Rearrange tasks by drag and drop | Have the tasks in the order that I | Tasks |
| | | want. | |
| Moderator | Have Task 1 be prepopulated to | Make creating tasks easier and have | Tasks |
| | the Explore task | one less to fill out. | |
| Moderator | Add questions to each section | Capture the data that I need. | Tasks |
| | within the Task Template | | |
| Moderator | Use a long-click on a button in | Add notes contextually as I quantify | Tasks |
| | order to add an additional note | data. | |
| Moderator | Choose when and if I see observer | Run the sessions how I want. | Observer |
| | questions | | Questions |
| | | | (Mod |
| | | | Guide) |
| Moderator | See observer questions during the | Ask questions as they come up. | Observer |
| | task portion of the sessions | | Questions |
| | | | (Mod |
| | | | Guide) |
| Moderator | Close the observer question pod | Not be distracted by observer | Observer |
| | during the task portion of the | questions if they get to be too much | Questions |
| | session | | (Mod |
| | | | Guide) |
| Moderator | See a counter on the Observer | See if I need to ask any questions | Observer |
| | Question navigation item of | later. | Questions |
| | questions the observers are asking | | (Mod |
| | | | Guide) |
| Moderator | See examples of the first two | Make a better informed decision. | Observer |
| | options | | Questions |
| | | | (Mod |
| | | | Guide) |
| Observer | Log into Capture and view the | Write notes to the moderator | Observer |
| | study I have permission to see | | Questions |
| Observer | Write questions to the moderator | Have my questions answered during | Observer |
| | | the session. | Questions |
| Observer | Switch between studies | Write/view questions to the | Observer |
| | | moderator | Questions |
| Moderator | Have the option to use a SUS | Get industry-related usability data | Post-Test |
| | (System Usability Scale) survey | without having to create my own | Questionnaire |
| | and have the ability to swap out | survey | |
| | the word ‘system with website, | | |
| | application, or mobile app | | |
| Moderator | Create a questionnaire from | Ask the post-test questions that I | Post-Test |
| | scratch | want | Questionnaire |
| Moderator | Have 3 questions populated for me | Reduce the number of questions I | Post-Test |
| | in the post-test interview | have to type into the app | Interview |
| Moderator | Uncheck the default post-test | Ask the post-test questions that I | Post-Test |
| | interview questions if I don't like | want | Interview |
| | them | | |
| Moderator | Add questions in the post-test | Ask the post-test questions that I | Post-Test |
| | interview | want | Interview |
| Moderator | Have the ability for participants to | Have less paper I have to deal with | Gratuities |
| | e-sign their gratuity receipt form | | |
| | and have it dated automatically | | |
| Moderator | Edit the text on the gratuity receipt | Have the language that I want (my | Gratuities |
| | form | company's lawyers want) | |
| Moderator | Indicate that the user has signed | Keep track of the things 1 have to do. | Gratuities |
| | the paper gratuity receipt form | | |
| Participant | Sign the gratuity receipt form | Not have to sign it on paper | Gratuities |
| Moderator | Have a checklist of things to do to | check off what I have done. | Thank |
| | wrap the session, similar to the | | You & |
| | introduction. | | Goodbye |
| Moderator | Have a text of things to do to wrap | Read specific text that I need to do. | Thank |
| | up the session, similar to the | | You & |
| | introduction | | Goodbye |
| Moderator | Select what data charts you want to | The quantified data that I captured | Charts |
| | see. Options should be Pass/Fail | during the session. | |
| | and then each task. | | |

TABLE 2
Tablet and Web Applications

| As A | I Want To | So I Can | Page |
|---|---|---|---|
| Moderator | Sign into the app | See my stuff and enter data | Sign In |
| Moderator | Resend/Reset Password | Get to my stuff | Sign In |
| Moderator | View the study names and updated | Pick a study to look at/enter data | Dashboard |
| | date | | |
| Moderator | Be able to navigate between | Get to the area that I want | All studies |
| | participants, observe, charts, and | | |
| | log within a study | | |
| Moderator | Be able to add media at any time. | Capture data on the fly | All studies |
| | Media is photo, video, audio, | | |
| | drawing, comment | | |
| Moderator | Be able to add a comment to any | Describe what the media is | All studies |
| | media | | |
| Moderator | Be able to view a gallery of media | Review media | All studies |
| Moderator | View participant info in a table and | Navigate the participant list so I | Participants |
| | be able to view completed sessions | can take notes in the correct order | |
| | or start future sessions | | |
| Moderator | Navigate to the next and previous | Move forward with the session | All observe |
| | sections at the top of the view | | pages |
| Moderator | View the agenda and be able to | See an overview of the session. | Agenda |
| | link to each section | | |
| Moderator | If checkmark view, check off the | Mark what I've told the | Introduction |
| | topics I've discuses in the intro | participant | |
| Participant | Sign the NDA and have it auto- | Not have another piece of paper | NDA |
| | date | | |
| Moderator | Indicate that the participant signed | Keep track of all the things I need | NDA |
| | a paper NDA | to do | |
| Participant | Answer questions using the tablet | Answer the questions the | Pre-Test |
| | | moderator wants me to | Questionnaire |
| Moderator | If add notes view, show me the | Qualify responses | Pre-Test |
| | answers the participant made | | Interview |
| | previously and put sticky notes on | | |
| | the view so I can add notes | | |
| Moderator | Have a list of all tasks on one page | Use this as a start page for the | Task List |
| | | tasks | |
| Moderator | Have the Go button turn into a | Know what tasks I've completed | Task List |
| | checkmark once the participant | | |
| | completes the task | | |
| Moderator | Be able to go back to the task by | Add data later | Task List |
| | the Task Name even if the | | |
| | participant completed the task | | |
| Moderator | View the 5 sections of a task | Do data entry for a complete task | Task Detail |
| Moderator | Start and stop the task timer and | Do time on task events so I know | Task Detail |
| | display it at the top of the page | how long it takes a participant to | |
| | | do something. | |
| Moderator | Show observer question pod if | See the questions my observers | Task Detail |
| | chosen in setup and hide it if | have but hide it also | |
| | necessary | | |
| Moderator | Answer all of the questions | Capture good data | Task Detail |
| Moderator | View a log of all questions the | Review the questions and make | Observer |
| | observers asked. Include who | sure all have been answered | Questions |
| | made the question and timestamp | before ending the session. | |
| Moderator | Have a visual cue that tells me the | Know how many questions there | Observer |
| | count of observer questions | are. | Questions |
| Participant | Fill out the answers to the | Answer the questions the | Post-Test |
| | questions | moderator wants me to | Questionnaire |
| Moderator | Ask the participant questions and | Capture data | Post-Test |
| | fill out the answers | | Interview |
| Participant | Sign the gratuity receipt form | Not have another piece of paper | Gratuities |
| Moderator | Indicate that the participant signed | Keep track of all the things I need | Gratuities |
| | a paper gratuity receipt form | to do | |
| Moderator | If checkmark view, check off the | Mark what I've told the | Thank you |
| | topics I've discuses in the goodbye | participant | and goodbye |
| Moderator | Single Choice - Date/Time - | See the date time as a text box | All pages |
| | Textbox | when I am running the sessions. | that have |
| | | | questions |
| Moderator | Single Choice - Date/Time - | See the date time as pull-downs | All pages |
| | Pulldowns | when I am running the sessions. | that have |
| | | | questions |
| Moderator | Single Choice - Date/Time - | See the date time as a calendar | All pages |
| | Calendar Picker | picker when I am running the | that have |
| | | sessions. | questions |
| Moderator | Single Choice - Dropdown | See the answers as pull-downs | All pages |
| | | when I am running the sessions. | that have |
| | | | questions |
| Moderator | Single Choice - Likert Scale - (3- | See the answers as a 3-10 point | All pages |
| | 10 options) | likert scale when I am running the | that have |
| | | sessions. | questions |
| Moderator | Single Choice - Likert Scale - | Have the ability to select N/A for | All pages |
| | include a N/A option | a question with a Likert Scale | that have |
| | | | questions |
| Moderator | Single Choice - Radio Buttons - | See the answers as vertical radio | All pages |
| | Vertical | buttons when I am running the | that have |
| | | sessions. | questions |
| Moderator | Single Choice - Radio Buttons - | See the answers as horizontal | All pages |
| | Horizontal | radio buttons when I am running | that have |
| | | the sessions. | questions |
| Moderator | Single Choice - Slider - (3-10 | See the answers as a slider with | All pages |
| | options) | 3-10 options when I am running | that have |
| | | the sessions. | questions |
| Moderator | Multiple Choice - Buttons - | See the answers as horizontal | All pages |
| | Horizontal | buttons when I am running the | that have |
| | | sessions and I can select more | questions |
| | | than one. | |
| Moderator | Multiple Choice - Buttons - | See the answers as vertical | All pages |
| | Vertical | buttons when I am running the | that have |
| | | sessions and I can select more | questions |
| | | than one. | |
| Moderator | Multiple Choice - Checkboxes - | See the answers as vertical | All pages |
| | Vertical | checkboxes when I am running | that have |
| | | the sessions and I can select more | questions |
| | | than one. | |
| Moderator | Multiple Choice - Checkboxes - | See the answers as horizontal | All pages |
| | Horizontal | checkboxes when I am running | that have |
| | | the sessions and I can select more | questions |
| | | than one. | |
| Moderator | Multiple Choice - Matrix - (1-8 | See the answers as matrix of | All pages |
| | columns) - radio buttons (single | choices that have 1-8 columns. | that have |
| | selection per row) | Ability to select one answer per | questions |
| | | row. | |
| Moderator | Multiple Choice - Matrix - (1-8 | See the answers as a matrix of | All pages |
| | columns) - checkmarks (multiple | choices that have 1-8 columns. | that have |
| | selections per row) | Ability to select multiple answers | questions |
| | | per row. | |
| Moderator | Ranking | Have the participant drag and | All pages |
| | | drop items into an order | that have |
| | | | questions |
| Moderator | Grouping - User-Defined Groups | Have the participant drag and | All pages |
| | | drop items into their own groups | that have |
| | | (card-sorting studies) | questions |
| Moderator | Grouping - Defined Groups | Have the participant drag items | All pages |
| | | into groups I define | that have |
| | | | questions |
| Moderator | Media - Picture | Take a picture as the answer to a | All pages |
| | | question. | that have |
| | | | questions |
| Moderator | Media - Video | Take a video as the answer to a | All pages |
| | | question. | that have |
| | | | questions |
| Moderator | Media - Voice Recording | Take a voice recording as the | All pages |
| | | answer to a question. | that have |
| | | | questions |
| Moderator | Media - Drawing | Allow user to draw on the ipad as | All pages |
| | | the answer to a question. | that have |
| | | | questions |
| Moderator | Text (1-5 rows) | Type in answers via an attached | All pages |
| | | keyboard or an on-screen touch | that have |
| | | keyboard | questions |
| Moderator | Ability to add questions to an | Ask multiple questions during a | All pages |
| | agenda section, having the first | session. | that have |
| | question populated by a Single | | questions |
| | Choice, Button, Vertical, 5 options | | |
| | question | | |
| Moderator | Edit questions | Make sure the questions are asked | All pages |
| | | and displayed correctly. | that have |
| | | | questions |
| Moderator | Delete questions | Remove questions I don't want. | All pages |
| | | | that have |
| | | | questions |
| Moderator | Rearrange questions by drag and | Order questions in a way that | All pages |
| | drop | makes sense to me. | that have |
| | | | questions |
| Moderator | Use the pre-test questionnaire as | Review what the participant | Pre-Test |
| | the basis for my interview. In the | answered with them and take | Interview |
| | data entry side, I want a sticky note | additional notes. | |
| | text box where I can type | | |
| | additional notes | | |
| Moderator | Create a home-grown interview | Ask questions that I want during | Pre-Test |
| | questionnaire where I create | the interview. | Interview |
| | questions from scratch | | |
| Moderator | Add Tasks to the moderator guide. | Have the participant run through | Tasks |
| | The Task Template has 5 parts: | desired functionality | |
| | 1 - Task Title (Textbox) | | |
| | 2 - Say to Participant (Text Area) | | |
| | 3 - Task Metrics (Time on Task, | | |
| | Pass/Fail, Task Answer) | | |
| | 4 - Observe (Errors, Common | | |
| | Usability Issues) | | |
| | 5 - Post-Task Questions (Likes, | | |
| | Dislikes, Ease of use, confidence) | | |
| Moderator | Delete tasks | Remove unwanted tasks. | Tasks |
| Moderator | Rearrange tasks by drag and drop | Have the tasks in the order that I | Tasks |
| | | want. | |
| Moderator | Have Task 1 be prepopulated to | Make creating tasks easier and | Tasks |
| | the Explore task | have one less to fill out. | |
| Moderator | Add questions to each section | Capture the data that I need. | Tasks |
| | within the Task Template | | |
| Moderator | Use a long-click on a button in | Add notes contextually as I | Tasks |
| | order to add an additional note | quantify data. | |
| Moderator | Choose when and if I see observer | Run the sessions how 1 want. | Observer |
| | questions | | Questions |
| | | | (Mod |
| | | | Guide) |
| Moderator | See observer questions during the | Ask questions as they come up. | Observer |
| | task portion of the sessions | | Questions |
| | | | (Mod |
| | | | Guide) |
| Moderator | Close the observer question pod | Not be distracted by observer | Observer |
| | during the task portion of the | questions if they get to be too | Questions |
| | session | much | (Mod |
| | | | Guide) |
| Moderator | See a counter on the Observer | See if I need to ask any questions | Observer |
| | Question navigation item of | later. | Questions |
| | questions the observers are asking | | (Mod |
| | | | Guide) |
| Moderator | See examples of the first two | Make a better informed decision. | Observer |
| | options | | Questions |
| | | | (Mod |
| | | | Guide) |
| Observer | Log into Capture and view the | Write notes to the moderator | Observer |
| | study I have permission to see | | Questions |
| Observer | Write questions to the moderator | Have my questions answered | Observer |
| | | during the session. | Questions |
| Observer | Switch between studies | Write/view questions to the | Observer |
| | | moderator | Questions |
| Moderator | Have the option to use a SUS | Get industry-related usability data | Post-Test |
| | (System Usability Scale) survey | without having to create my own | Questionnaire |
| | and have the ability to swap out the | survey | |
| | word ‘system with website, | | |
| | application, or mobile app | | |
| Moderator | Create a questionnaire from | Ask the post-test questions that I | Post-Test |
| | scratch | want | Questionnaire |
| Moderator | Have 3 questions populated for me | Reduce the number of questions I | Post-Test |
| | in the post-test interview | have to type into the app | Interview |
| Moderator | Uncheck the default post-test | Ask the post-test questions that I | Post-Test |
| | interview questions if I don't like | want | Interview |
| | them | | |
| Moderator | Add questions in the post-test | Ask the post-test questions that I | Post-Test |
| | interview | want | Interview |
| Moderator | Have the ability for participants to | Have less paper I have to deal | Gratuities |
| | e-sign their gratuity receipt form | with | |
| | and have it dated automatically | | |
| Moderator | Edit the text on the gratuity receipt | Have the language that I want | Gratuities |
| | form | (my company's lawyers want) | |
| Moderator | Indicate that the user has signed | Keep track of the things I have to | Gratuities |
| | the paper gratuity receipt form | do. | |
| Participant | Sign the gratuity receipt form | Not have to sign it on paper | Gratuities |
| Moderator | Have a checklist of things to do to | check off what I have done. | Thank You |
| | wrap the session, similar to the | | & Goodbye |
| | introduction. | | |
| Moderator | Have a text of things to do to wrap | Read specific text that I need to | Thank You |
| | up the session, similar to the | do. | & Goodbye |
| | introduction | | |
| Moderator | Display the quantitative data that | View charts quickly | Charts |
| | was captured during the data entry | | |
| Moderator | Share the data charts | Send them to my team members | Charts |
| Moderator | View the data log that was | See the timestamps of what I | Log |
| | captured | captured and the raw notes. | |
| Moderator | View the data log by participant | Look at the data by participant | Log |
| | and be able to change participants | | |

That which is claimed is:

1. A communication system for conducting at least one user experience study, the communication system comprising:
a server comprising a processor and memory associated therewith; and
a plurality of communications devices respectively associated with a plurality of participants for the at least one user experience study, each communications device comprising a processor and memory associated therewith;
said server configured to
generate a participant interface for conducting the at least one user experience study with the plurality of participants via said plurality of communications devices, and
generate user experience data from the at least one user experience study and store the user experience data in said memory.

2. The communication system of claim 1 wherein said server is configured to provide the at least one user experience study for download via said plurality of communications devices.

3. The communication system of claim 1 wherein each communications device comprises at least one input device and at least one sensor device; and wherein said server is configured to generate the user experience data by at least collecting data from said at least one input device and said at least one sensor device.

4. The communication system of claim 1 wherein said server is configured to send at least one recruiting message to potential participants.

5. The communication system of claim 4 wherein said server is configured to store historical data regarding prior participants from at least one prior user experience study, and select the potential participants based upon the stored historical data.

6. The communication system of claim 1 wherein said server is configured to provide a moderator interface for moderating the at least one user experience study.

7. The communication system of claim 6 wherein the moderator interface comprises a pre-test questionnaire, at least one observer question, and a post-test interview.

8. The communication system of claim 6 wherein the moderator interface is configured to receive moderator data regarding the at least one user experience study.

9. The communication system of claim 1 wherein said server is configured to provide an observer interface.

10. The communication system of claim 1 wherein each communications device comprises at least one of a tablet computing device, a personal computing device, and a mobile cellular device.

11. A server in a communication system for conducting at least one user experience study, the communication system comprising a plurality of communications devices respectively associated with a plurality of participants for the at least one user experience study, the server comprising:
a processor and memory associated therewith and configured to
generate a participant interface for conducting the at least one user experience study with the plurality of participants via said plurality of communications devices, and
generate user experience data from the at least one user experience study and store the user experience data in said memory.

12. The server of claim 11 wherein said processor and memory are configured to provide the at least one user experience study for download via said plurality of communications devices.

13. The server of claim 11 wherein each communications device comprises at least one input device and at least one sensor device; and wherein said processor and memory are configured to generate the user experience data by at least collecting data from said at least one input device and said at least one sensor device.

14. The server of claim 11 wherein said processor and memory are configured to send at least one recruiting message to potential participants.

15. The server of claim 14 wherein said processor and memory are configured to store historical data regarding prior participants from at least one prior user experience study, and select the potential participants based upon the stored historical data.

16. The server of claim 11 wherein said processor and memory are configured to provide a moderator interface for moderating the at least one user experience study.

17. The server of claim 16 wherein the moderator interface comprises a pre-test questionnaire, at least one observer question, and a post-test interview.

18. The server of claim 16 wherein the moderator interface is configured to receive moderator data regarding the at least one user experience study.

19. The server of claim 11 wherein said processor and memory are configured to provide an observer interface.

20. A method for operating a server in a communication system for conducting at least one user experience study, the communication system comprising a plurality of communications devices respectively associated with a plurality of participants for the at least one user experience study, the method comprising:
operating a processor and memory associated therewith in the server to
generate a participant interface for conducting the at least one user experience study with the plurality of participants via said plurality of communications devices, and
generate user experience data from the at least one user experience study and store the user experience data in said memory.
